(19) United States
(12) Patent Application Publication
(10) Pub. No.: US 2010/0004154 A1
(43) Pub. Date: Jan. 7, 2010

(54) THERMALLY SENSITIVE POLYMERIC DYE TRANSFER INHIBITOR

(75) Inventors: Juergen Detering, Limburgerhof (DE); Heike Becker, Mannheim (DE); Richard Baur, Mutterstadt (DE); Guido Vandermeulen, Ilvesheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/519,786

(22) PCT Filed: Dec. 20, 2007
(86) PCT No.: PCT/EP2007/064393

§ 371 Date: Jun. 18, 2009

(30) Foreign Application Priority Data
Dec. 21, 2006 (EP) 06126939.5

(51) Int. Cl. C11D 3/37

(52) U.S. Cl. 510/360; 510/276; 528/323; 528/327; 528/361

(57) ABSTRACT

The invention relates to the use of thermally sensitive polymers as dye transfer inhibitors. The invention also relates to novel thermally sensitive polymers suitable as dye transfer inhibitors, and to washing compositions which comprise these polymers.

The invention relates to the use of thermally sensitive polymers as dye transfer inhibitors. The invention also relates to novel thermally sensitive polymers suitable as dye transfer inhibitors, and to washing compositions which comprise these polymers.

During the washing operation, dye molecules are often detached from colored textiles and can in turn attach to other textiles. In order to counteract this undesired dye transfer, so-called dye transfer inhibitors are often used. They are frequently polymers which comprise monomers with nitrogen-heterocyclic radicals in copolymerized form.

For example, DE 4235798 describes copolymers of 1-vinylpyrrolidone, 1-vinylimidazole, 1-vinylimidazolium compounds or mixtures thereof; further nitrogen-containing, basic ethylenically unsaturated monomers; and if appropriate other monoethylenically unsaturated monomers and use thereof for inhibiting dye transfer during the washing operation.

Similar copolymers are described for this purpose in DE 19621509 and WO 98/30664.

Some of the copolymers described in these documents feature good inhibition of dye transfer in washing processes. However, they generally have low compatibility with the further customarily used washing composition constituents. For instance, especially in the case of liquid washing compositions, there is the risk of incompatibilities, for example in the form of opacity or phase separations.

There have been various descriptions of the use of thermally sensitive polymers with a lower critical solution temperature (LCST) in washing and cleaning composition formulations.

GB 2377451 discloses a cleaning composition for a machine dishwasher, wherein a surfactant is surrounded by a water-soluble polymer which retards its release until the cloud point of the surfactant has been exceeded in the machine.

JP 09192469 describes a surfactant composition comprising an LCST polymer. The surfactant action can be controlled via the temperature.

WO 2001/40420 describes a washing and cleaning composition with customary ingredients, which comprises an active ingredient formulation which has been formulated with an LCST polymer.

DE 19958472 discloses a particulate composite material for the controlled release of an active ingredient comprising an active ingredient or a formulation which comprises this active ingredient in a mixture with an LCST substance.

WO 2002/08137 discloses a particulate composite material for the controlled release of an active ingredient or of an active ingredient formulation, in which the active ingredient or the active ingredient formulation has been coated with an LCST polymer. The LCST polymer is mixed with an additive with which the film formation can be improved and/or the LCST temperature can be adjusted.

WO 2002/44462 describes a particulate textile aftertreatment composition which comprises a textile care active ingredient which is formulated such that the majority of the active ingredient is released in the main wash cycle in a retarded manner or not until after the main wash cycle. For example, the active ingredient can be coated with an LCST polymer.

DE 10064635 describes washing or cleaning composition tablets composed of compacted particulate washing or cleaning compositions, comprising builder(s), surfactant(s) and if appropriate further washing or cleaning composition constituents, which is formulated such that it has retarded solubility on contact with the water.

DE 10148353 describes a process for forming a release retardation layer on washing and cleaning composition tablets with an LCST functional layer.

WO 2001/044433 relates to a laundry detergent, dishwasher detergent or cleaning composition portion comprising two or more washing- or cleaning-active components of which at least two are to be released into the liquor at different times in a washing or cleaning operation, comprising at least one (physico)chemical switch which controls the release and is not exclusively subject, if at all, to thermal control, and also one or more substance(s) for increasing the extent of the shift in the pH.

In all cases, the LCST polymer in the compositions serves to control the release of the active constituent (active ingredient/surfactant) present in the composition via the temperature.

It was an object of the present invention to provide substances with a good dye transfer-inhibiting action in the washing operation. These substances should additionally have good compatibility with conventional washing composition constituents, especially in the case of liquid washing composition formulations.

These and further objects are surprisingly solved by thermally sensitive polymers which have a lower critical solution temperature (LCST).

The invention therefore relates to the use of thermally sensitive polymers which have a lower critical solution temperature (LCST) as dye transfer inhibitors in washing compositions for textiles.

The invention also relates to a process for washing colored textiles, in which
(a) the textiles are contacted with at least one thermally sensitive polymer which has an LCST and at least one surfactant in a wash liquor,
(b) the temperature of the wash liquor is raised to the LCST of the at least one thermally sensitive polymer or a higher temperature, and
(c) the at least one thermally sensitive polymer is removed from the textiles with the wash liquor.

The process according to the invention is suitable particularly for performance as a machine wash, for example in a commercial fully automatic washing machine.

In the present context, thermally sensitive refers to a polymer which has an LCST. This is understood by the person skilled in the art to mean a polymer whose solubility in aqueous solution depends on temperature to the extent that it is soluble in water below the LCST and is insoluble above the LCST. Accordingly, a polymer-water mixture is monophasic below the LCST. Above the LCST, this polymer-water mixture exhibits demixing. In such cases, it is also said that the polymer has a negative temperature-dependent solubility coefficient.

The LCST is that temperature above which a water-polymer mixture becomes cloudy (cloud point). The cloud point or the LCST can be determined by heating a solution of the polymer in water over a particular temperature range with a particular heating rate. In the literature, various methods of measuring the cloud point are employed. Examples are visual determination or spectrophotometric measurement, the transmission of the solution being monitored as a function of temperature at a particular wavelength.

Cloud points in this application are determined by means of transmission measurement at 550 nm of 1% by weight polymer solutions (temperature range from 20 to 85° C., heating rate 1° C. per minute).

It is suspected that the favorable properties of the polymers used in accordance with the invention are based on the following connections: at temperatures below the LCST, the dye transfer inhibitor binds or complexes free dye in the wash liquor via dye-affinitive groups. At temperatures at or above the LCST, the dye transfer inhibitor becomes hydrophobic and therefore insoluble. The dye is enclosed or retained by the dye transfer inhibitor and can be removed from the textile in the wash cycle, for example when the hot wash liquor is pumped out.

The LCST of the polymers used in accordance with the invention is generally at least 20° C. It is, for example, in the range from 20 to 95° C., preferably in the range from 25 to 80° C. and in particular in the range from 30 to 60° C.

Polymers which have an LCST are known to those skilled in the art, for example from the prior art cited at the outset. The LCST of the polymers used in accordance with the invention depends upon factors including the chemical composition, the molecular weight and the concentration of the polymer. For example, it is known that the LCST can be increased by the inclusion in the polymer of a larger proportion of a hydrophilic monomer.

Suitable polymeric dye transfer inhibitors are in principle all polymers which have an LCST in water which is preferably within the abovementioned temperature ranges. Examples thereof are
i) alkylated and hydroxyalkylated polysaccharides, such as hydroxypropylmethylcellulose (HPMC), ethyl(hydroxyethyl)cellulose (EHEC), hydroxypropylcellulose (HPC), methylcellulose (MC) and mixtures thereof, and also mixtures of alkylated and/or hydroxyalkylated polysaccharides with carboxymethylcellulose;
ii) polyvinylcaprolactam, poly(N-alkyl)acrylamides and poly(N,N-dialkylacrylamides),
iii) poly(hydroxypropyl acrylate) and poly(hydroxypropyl methacrylate),
iv) polyethylene oxides and ethylene oxide/propylene oxide copolymers, and also graft copolymers based on alkylated acrylamides with polyethylene oxide,
v) polyvinyl alcohol and partially hydrolyzed polyvinyl acetates;
vi) polyvinyl methyl ether,
vii) particular proteins such as poly(VAPGVV) (where V=valine, A=alanine, P=proline, G=glycine).

Surprisingly, copolymers based on ethylenically unsaturated monomers M which comprise at least one monoethylenically unsaturated monomer (a) whose homo- or copolymers exhibit thermally sensitive behavior (i.e. have an LCST), and at least one monoethylenically unsaturated monomer (b) with a dye-affinitive group also have an LCST. They are particularly suitable as dye transfer inhibitors.

Such copolymers may also be prepared by polymerizing the monomers M in the presence of a graft base. Such polymers are novel and likewise form part of the subject matter of the present invention.

The invention accordingly relates to a copolymer which is suitable as a dye transfer inhibitor and comprises units (a) of at least one ethylenically unsaturated monomer whose homo- or copolymers exhibit thermally responsive behavior, (b) at least one ethylenically unsaturated monomer with a dye-affinitive group and, if appropriate, a graft base.

Based on the total amount of the monomers M, the monomer (a) (or a combination of different monomers (a)) makes up from 20 to 80% by weight, especially from 30 to 70% by weight, and the monomer (b) (or a combination of monomers (b)) from 5 to 50% by weight, preferably from 10 to 40% by weight. The copolymer may comprise units of further monomers (c) other than the monomers (a) and (b). When units of further monomers are present, their amount is preferably less than 40% by weight, in particular less than 30% by weight, based on the total amount of the monomers M, and preferably less than 70% by weight, in particular less than 50% by weight, based on the sum of the units of monomers (a) and (b). When the copolymer is prepared in the presence of a graft base, its proportion is preferably less than 100% by weight, in particular less than 60% by weight, for example from 5 to 100% by weight, in particular from 10 to 60% by weight, based on the sum of the units derived from the monomers M.

The person skilled in the art is familiar with ethylenically unsaturated monomers (a) whose homo- or copolymers exhibit thermally sensitive behavior and which are suitable for preparing an inventive dye transfer inhibitor.

These monomers are, for example, selected from
N-vinyllactams having a ring size of at least 6 atoms, especially from N-vinylcaprolactams and N-vinylvalerolactams, e.g. N-vinyl-3-methyl-ε-caprolactam, N-vinyl-ε-caprolactam and N-vinyl-δ-valerolactam;
N-mono-C₁-C₈-alkyl(meth)acrylamides such as N-isopropylacrylamide;
N,N-di-C₁-C₈-alkyl(meth)acrylamides such as N,N-dimethylacrylamide and N,N-dimethylmethacrylamide;
hydroxy-C₂-C₄-alkyl(meth)acrylates such as hydroxypropyl acrylate;
vinyl alcohol prepared, for example, by hydrolysis of vinyl acetate; and
vinyl C₁-C₈-alkyl ethers such as vinyl methyl ether.

Among these, preference is given to N-vinylcaprolactam, N-isopropylacrylamide, hydroxypropyl acrylate, vinyl alcohol and vinyl methyl ether. N-Vinylcaprolactam is particularly preferred.

Dye-affinitive groups are functional groups which exhibit a high affinity for dyes such as direct dyes, reactive dyes and acid dyes. The nature of the interaction with the dye may be based on hydrogen bonds, π-π interactions, electrostatic forces such as ion/ion interactions, ion/dipole interactions, intercalation or combinations or other suitable interactions.

The dye-affinitive group in the monomer (b) is preferably a 5- or 6-membered nitrogen heterocycle which may be fused. The 5- or 6-membered nitrogen heterocycle (N-heterocycle) may be aromatic (heteroaryl) or partly or fully saturated. In addition, the N-heterocycle may optionally have one or more, for example 1, 2, 3 or 4, substituents selected from C₁-C₄-alkyl, C₃-C₆-cycloalkyl and phenyl. Moreover, the N-heterocycle may have a carbonyl group and/or an N-oxide group as a ring member. In addition, the N-heterocycle may be present in quaternized form, for example by alkylation of at least one ring nitrogen atom. Furthermore, the N-heterocycle may also be present as a betainic structure in which at least one nitrogen atom of the heterocycle is bridged via a C₁-C₂₀-alkanediyl group to an anionic group selected from —SO₃⁻, —OSO₃⁻, —COO⁻, —OPO(OH)O⁻, —OPO(OR^{f})O⁻ or —PO(OH)O⁻, where R^{f} is C₁-C₆-alkyl. The nitrogen heterocycle may be fused to one or more ring systems. The fused ring systems may be saturated, partly unsaturated or aromatic. A preferred fused ring system is a benzene ring.

In addition to the dye-affinitive group, the monomer has an ethylenically unsaturated group via which the monomer is incorporated into the polymeric structure of the dye transfer inhibitor in the copolymerization. Suitable ethylenically unsaturated groups are, for example, C₂-C₆-alkenyl radicals, especially vinyl radicals, or (meth)acryloyloxy or (meth)acrylamino groups.

The monomers with a dye-affinitive group include 5-membered lactams which bear, on their nitrogen atom, a C₂-C₆-alkenyl radical, especially a vinyl radical. Such lactams may be described by the general formula (I):

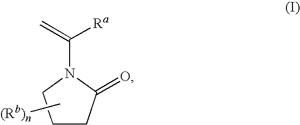

in which
n is 0, 1 or 2;
R^{a} is H or C₁-C₄-alkyl;
R^{b} is C₁-C₄-alkyl, i.e. one or more of the CH₂ groups which form the lactam ring optionally have 1 or 2 substituents selected from C₁-C₄-alkyl.

Examples of such N-vinyllactams are N-vinylpyrrolidones, e.g. N-vinyl-3-methylpyrrolidone and N-vinylpyrrolidone. A preferred N-vinyllactam is N-vinylpyrrolidone.

Also suitable are N-vinyloxazolidones, e.g. N-vinyl-5-methyloxazolidone and N-vinyloxazolidone.

The monomers with a dye-affinitive group also include N-vinylheterocyclic monomers with an N-heterocycle selected from imidazoles, imidazolines and imidazolidines, pyridines, pyrroles, pyrrolidines, quinolines, isoquinolines, purines, pyrazoles, triazoles, tetraazoles, indolizines, pyridazines, pyrimidines, pyrazines, indoles, isoindoles, oxazoles, oxazolidines, morpholines, piperazines, piperidines, isoxazoles, thiazoles, isothiazoles, indoxyls, isatins, dioxindoles and hydantoins and derivatives thereof, for example barbituric acid, uracil and derivatives thereof. The monomers mentioned may also be used in the form of betainic derivatives or quaternized products.

The N-heterocycles are selected in particular from imidazoles, triazoles, pyridines, pyridine N-oxides, and also betainic derivatives and quaternization products thereof, especially from imidazoles.

In a preferred embodiment, the monomers are selected from N-vinylimidazoles of the general formula IV a, betainic N-vinylimidazoles of the general formula IV b, 2- and 4-vinylpyridines of the general formulae IV c and IV d, and betainic 2- and 4-vinylpyridines of the general formulae IV e and IV f:

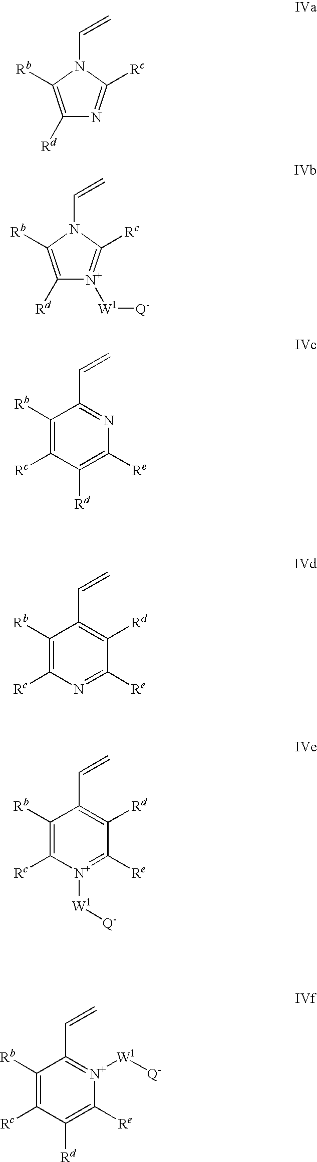

in which
R^{b}, R^{c}, R^{d}, R^{e} are each independently H, C₁-C₄-alkyl or phenyl, preferably H or C₁-C₄-alkyl, more preferably H;
W¹ is C₁-C₂₀-alkylene, for example —CH₂—, —CH(CH₃)—, —(CH₂)₂—, —CH₂—CH(CH₃)—, —(CH₂)₃—, —(CH₂)₄—, —(CH₂)₅—, —(CH₂)₆—, preferably C₁-C₃-alkylene; especially —CH₂—, —(CH₂)₂— or —(CH₂)₃—;
Q⁻ is —SO₃⁻, —OSO₃⁻, —COO⁻, —OPO(OH)O⁻, —OPO(OR^{f})O⁻ or —PO(OH)O⁻; and
R^{f} is C₁-C₂₄-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, iso-amyl, n-hexyl, isohexyl, sec-hexyl, n-heptyl, n-octyl, n-nonyl, n-decyl; more preferably C₁-C₄-alkyl.

Also suitable are the acrylic or methacrylic esters of hydroxyalkyl-substituted N-heterocycles, where the N-heterocycle is selected from imidazoles, imidazolines and imidazolidines, pyridines, pyrroles, pyrrolidines, quinolines, isoquinolines, purines, pyrazoles, triazoles, tetraazoles, indolizines, pyridazines, pyrimidines, pyrazines, indoles, isoindoles, oxazoles, oxazolidines, morpholines, piperazines, piperidines, isoxazoles, thiazoles, isothiazoles, indoxyls, isatins, dioxindoles and hydantoins and derivatives thereof. Suitable monomers are, for example, hydroxyethylpyrrolidone (meth)acrylate or hydroxyethylimidazole (meth)acrylate.

Preferred N-vinylheterocyclic monomers are N-vinylimidazole and C₁-C₄-alkylvinylimidazoles, e.g. N-vinyl-2-methylimidazole, N-vinyl-4-methylimidazole, N-vinyl-5-methylimidazole, N-vinyl-2-ethylimidazole, in particular N-vinylimidazole and methylvinylimidazoles, especially N-vinylimidazole and N-vinyl-2-methylimidazole; 3-vinylimidazole N-oxide; 2- and 4-vinylpyridines, e.g. 2-vinyl-4-methylpyridine, 2-vinyl-6-methylpyridine and 2- and 4-vinylpyridine; vinylpyridine N-oxides such as 2- and 4-vinylpyridine N-oxides, e.g. 2-vinyl-4-methylpyridine N-oxide, 4-vinyl-2-methylpyridine-N-oxide and 2- and 4-vinylpyridine N-oxide; and also betainic derivatives and quaternization products thereof.

Particularly preferred betainic monomers are monomers of the formulae IV b, IV e and IV f in which the W¹-Q⁻ moiety is —CH₂—COO⁻, —(CH₂)₂—SO₃⁻ or —(CH₂)₃—SO₃⁻ and R^{b}, R^{c}, R^{d}, R^{e} are each H.

The quaternized monomers used are preferably vinylimidazoles and vinylpyridines, which may be quaternized before or after the polymerization. Particular preference is given to using 1-methyl-3-vinylimidazolium methosulfate and methochloride.

The quaternization can be undertaken especially with alkylating agents such as alkyl halides, which generally have from 1 to 24 carbon atoms in the alkyl radical, or dialkyl sulfates, which generally comprise alkyl radicals having from 1 to 10 carbon atoms. Examples of suitable alkylating agents from these groups are methyl chloride, methyl bromide, methyl iodide, ethyl chloride, ethyl bromide, propyl chloride, hexyl chloride, dodecyl chloride, lauryl chloride, and also dimethyl sulfate and diethyl sulfate. Further suitable alkylating agents are, for example, benzyl halides, especially benzyl chloride and benzyl bromide; chloroacetic acid; methyl fluorosulfate; diazomethane; oxonium compounds such as trimethyloxonium tetrafluoroborate; alkylene oxides such as ethylene oxide, propylene oxide and glycidol, which are used in the presence of acids; cationic epichlorohydrins. Preferred quaternizing agents are methyl chloride, dimethyl sulfate and diethyl sulfate.

The quaternization may also be performed in a polymer-analogous manner.

In a preferred embodiment, the monomers (b) with a dye-affinitive group are selected from N-vinylimidazole, quaternized N-vinylimidazole, N-vinylpyrrolidone, N-vinyltriazole, N-vinylbenzimidazole, hydroxyethylpyrrolidone (meth)acrylate and hydroxyethylimidazole (meth)acrylate, 2-vinylpyridine, 4-vinylpyridine and derivatives thereof, for example 4-vinylpyridine N-oxide.

In a particularly preferred embodiment, the monomers with a dye-affinitive group are selected from N-vinylpyrrolidone, N-vinylimidazole and mixtures of N-vinylpyrrolidone with N-vinylimidazole.

In addition to the monomers (a) and (b), the inventive copolymers may comprise one or more further monomers (c) copolymerizable with the monomers (a) and (b) in copolymerized form. Examples of monomers (c) are
monoethylenically unsaturated C₃-C₁₀-mono- and C₄-C₁₁-dicarboxylic acids, e.g. (meth)acrylic acid, crotonic acid, fumaric acid and maleic acid;
ethylenically unsaturated sulfonic acids and salts thereof, such as vinylsulfonic acid, 2-acryloyloxyethanesulfonic acid, 2- and 3-acryloyloxypropanesulfonic acid, 2-methyl-2-acrylamidopropanesulfonic acid and styrenesulfonic acid, and their sodium salts;
vinyl esters of saturated C₁-C₁₀-carboxylic acids, e.g. vinyl acetate and vinyl propionate; allyl ethers of linear or branched C₁-C₁₀-alcohols, e.g. allyl methyl ether, allyl ethyl ether and allyl propyl ether;
N-vinylamides of aliphatic carboxylic acids, especially N-vinylformamides, e.g. N-vinyl-N-methylformamide and N-vinylformamide itself;
the quaternary products of N-vinyl- and N-allylamines, such as alkylated N-vinyl- and N-allylamines, e.g. N-vinylmethylamine, N-vinylethylamine, N-allylmethylamine, N-allylethylamine and N-allylpropylamine;
the esters of monoethylenically unsaturated C₃-C₆-monocarboxylic acids or C₄-C₆-dicarboxylic acids with linear or branched aliphatic C₁-C₁₀-alcohols, e.g. methyl acrylate, ethyl acrylate, methyl methacrylate, ethyl methacrylate, dimethyl maleate, diethyl maleate, 2-ethylhexyl acrylate and 2-ethylhexyl methacrylate; the monoesters of monoethylenically unsaturated C₄-C₆-dicarboxylic acids with linear or branched C₁-C₁₀-alcohols, e.g. monomethyl maleate and monoethyl maleate;
the anhydrides of monoethylenically unsaturated C₄-C₆-dicarboxylic acids, e.g. maleic anhydride;
unsaturated nitriles, e.g. acrylonitrile and methacrylonitrile; and the salts of the acids mentioned, the derivatives thereof and mixtures thereof; and
monoethylenically unsaturated compounds with a poly-C₂-C₆-alkylene oxide group.

Monoethylenically unsaturated compounds with a poly-C₂-C₆-alkylene oxide group, which are also referred to hereinafter as polyalkylene oxide monomers, are typically compounds which have a polyether group and a molecular moiety having an ethylenically unsaturated double bond, the polyether group being formed from repeat units derived from alkylene oxides (polyalkylene oxide group). These include in particular the monomers of the general formula X

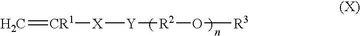

in which the variables are each defined as follows:
X is —CH₂— or —CO— when Y is —O—;
   is —CO— when Y is —NH—;
R¹ is hydrogen or methyl;
R² are identical or different C₂-C₆-alkylene radicals which may be linear or branched and which may be arranged in blocks or randomly, especially identical or different linear or branched C₂-C₄-alkylene radicals arranged in blocks or randomly, preferably ethylene, 1,2- or 1,3-propylene or mixtures thereof, more preferably ethylene;
R³ is hydrogen or C₁-C₄-alkyl, especially hydrogen or methyl;
n is an integer from 3 to 50, especially from 5 to 30,
   and mixtures thereof, where n on average has a value in the range from 3 to 50 (number-average). Among these, preference is given to those compounds in which at least 50 mol % of the R² groups are CH₂—CH₂. Among these, preference is given especially to those compounds in which X is CH₂ or CO. Among these, preference is given especially to those compounds in which Y is O.

The requirements of particular applications may influence the selection of the type and amount of the monomers (c). For instance, it may be desirable to react the inventive polymers further in a selective manner before use, for example by controlled alcoholysis, aminolysis or hydrolysis. For instance, it is possible in particular to form units corresponding to vinyl alcohol units from vinyl ester units, and units corresponding to vinylamine units from vinylformamide units.

In a preferred embodiment, the monomer (c) is selected from monoethylenically unsaturated polyalkylene oxide monomers, especially from the monomers of the formula X.

The monomers (C) are, corresponding to the formula X, for example:
reaction products of (meth)acrylic acid with polyalkylene glycols which are not end group-capped, are end group-capped at one end by alkyl radicals, are aminated at one end, or are end group-capped at one end by alkyl radicals and aminated at one end;
allyl ethers of polyalkylene glycols which are not end group-capped or are end group-capped at one end by alkyl, phenyl or alkylphenyl radicals.

Preferred monomers of the formula X are the (meth)acrylates and the allyl ethers, particular preference being given to the acrylates and in particular the methacrylates.

Particularly suitable examples of monomers (C) which are described by the formula X include:
methylpolyethylene glycol (meth)acrylate and (meth)acrylamide, methylpolypropylene glycol (meth)acrylate and (meth)acrylamide, methylpolybutylene glycol(meth)acrylate and (meth)acrylamide, methylpoly(propylene oxide-co-ethylene oxide) (meth)acrylate and (meth)acrylamide, ethylpolyethylene glycol (meth)acrylate and (meth)acrylamide, ethylpolypropylene glycol (meth)acrylate and (meth)acrylamide, ethylpolybutylene glycol (meth)acrylate and (meth)acrylamide and ethylpoly(propylene oxide-co-ethylene oxide) (meth)acrylate and (meth)acrylamide, with in each case from 3 to 50, preferably from 3 to 30 and more preferably from 5 to 30 alkylene oxide units, preference being given to methylpolyethylene glycol acrylate and particular preference to methylpolyethylene glycol methacrylate;
ethylene glycol allyl ether and methylethylene glycol allyl ether, propylene glycol allyl ether and methylpropylene glycol allyl ether having in each case from 3 to 50, preferably from 3 to 30 and more preferably from 5 to 30 alkylene oxide units.

In a first preferred embodiment of inventive copolymers, the proportion of monomers (c) is less than 5% by weight, especially less than 1% by weight, based on the total weight of the monomers M used to prepare the copolymer. Such polymers are preferably prepared in the presence of a graft base.

In a further preferred embodiment of inventive copolymers, the proportion of monomers (c) is from 1 to 40% by weight, especially from 5 to 30% by weight, based on the total weight of the monomers M used to prepare the copolymer. Such polymers are preferably not prepared in the presence of a graft base.

The copolymers may be prepared in the presence of a graft base. The graft base is typically a water-soluble polymer (at 20° C.) which, if appropriate, may also have an LCST. The graft base is preferably selected from poly-C₂-C₄-alkylene ethers and poly-C₂-C₄-alkyleneimines.

The number-average molecular weight Mₙ of the graft base is typically in the range from 300 to 100 000, especially in the range from 500 to 50 000.

The graft base of the inventive copolymers is preferably a poly-C₂-C₄-alkylene ether. The term “copolymer” is also intended to include oligomeric compounds.

The polyethers preferably have a number-average molecular weight Mₙ of at least 300 and have the general formula IIIa

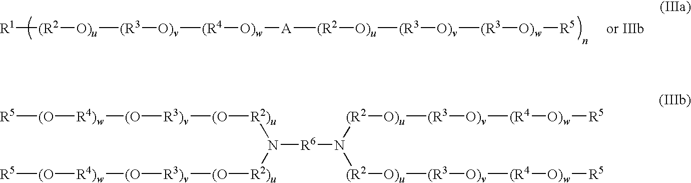

in which the variables are each defined as follows:
R¹ is hydroxyl, amino, C₁-C₂₄-alkoxy, R⁷—COO—, R⁷—NH—COO—, polyalcohol radical;
R², R³, R⁴ are the same or different and are each selected from —(CH₂)₂—, —(CH₂)₃—, —(CH₂)₄—, —CH₂—CH(CH₃)—, —CH₂—CH(CH₂—CH₃)—, —CH₂—CHOR⁸—CH₂—;
R⁵ is hydrogen, amino-C₁-C₆-alkyl, C₁-C₂₄-alkyl, R⁷—CO—, R⁷—NH—CO—;
R⁶ is C₁-C₂₀-alkylene whose carbon chain may be interrupted by from 1 to 10 oxygen atoms in ether function;
R⁷ is C₁-C₂₄-alkyl;
R⁸ is hydrogen, C₁-C₂₄-alkyl, R⁷—CO—;
A is a chemical bond, —CO—O—, —CO—B—CO—O—, —CO—NH—B—NH—CO—O—, —(CH₂)ₜ—, optionally substituted arylene;
B is —(CH₂)ₜ—, arylene which is substituted if desired;
n is 1 or, when R¹ is a polyalcohol radical, from 1 to 8;
s is from 0 to 500;
t is from 1 to 12;
u are the same or different and are each from 1 to 5000;
v are the same or different are each from 0 to 5000;
w are the same or different and are each from 0 to 5000.

The sum of n, u, v and w is selected such that the specific molecule or the molecule mixture has a molecular weight within the range specified above.

A preferred graft base is the polyethers of the formula IIIa.

The graft base is a polyether from the group of the polyalkylene oxides based on ethylene oxide, propylene oxide and butylene oxides, polytetrahydrofuran and polyglycerol.

Depending on the type of the monomer units, polymers are formed with the following structural units: —(CH₂)₂—O—, —(CH₂)₃—O—, —(CH₂)₄—O—, —CH₂—CH(CH₃)—O—, —CH₂—CH(CH₂—CH₃)—O—, —CH₂—CHOR⁸—CH₂—O—.

Both homopolymers and copolymers are suitable, and the copolymers may be randomly distributed or be present in the form of block polymers.

The terminal primary hydroxyl groups of the polyethers prepared on the basis of alkylene oxides or glycerol, and also the secondary OH groups of polyglycerol, may be present either in free form or else etherified with C₁-C₂₄-alcohols, esterified with C₁-C₂₄-carboxylic acids or reacted with isocyanates to give urethanes. Alcohols suitable for this purpose are, for example: primary aliphatic alcohols such as methanol, ethanol, propanol and butanol, primary aromatic alcohols such as phenol, isopropylphenol, tert-butylphenol, octylphenol, nonylphenol and naphthol, secondary aliphatic alcohols such as isopropanol, tertiary aliphatic alcohols such as tert-butanol, and polyhydric alcohols, e.g. diols such as ethylene glycol, diethylene glycol, propylene glycol, 1,3-propanediol and butanediol, and triols such as glycerol and trimethylolpropane. The hydroxyl groups may, however, also be exchanged for primary amino groups by reductive amination with hydrogen-ammonia mixtures under pressure, or be converted to aminopropylene end groups by cyanoethylation with acrylonitrile and hydrogenation. The capping of the hydroxyl end groups cannot only be effected subsequently by reaction with the alcohols or with alkali metal hydroxide solutions, amines and hydroxylamines, but rather these compounds may, like Lewis acids, e.g. boron trifluoride, also be used as starters at the beginning of the polymerization.

Finally, the hydroxyl groups may also be capped by reaction with alkylating agents such as dimethyl sulfate.

The alkyl radicals in the formulae IIIa and IIIb may be branched or unbranched C₁-C₂₄-alkyl radicals, preference being given to C₁-C₁₂-alkyl radicals and particular preference to C₁-C₆-alkyl radicals. Examples include methyl, ethyl, n-propyl, 1-methylethyl, n-butyl, 1-methylpropyl, 2-methylpropyl, 1,1-dimethylethyl, n-pentyl, 1-methylbutyl, 2-methyl-butyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-ethylhexyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl and n-eicosyl.

The number-average molecular weight Mₙ of the polyethers is at least 300 and is generally less than 100 000. It is preferably from 500 to 50 000, more preferably from 500 to 10 000 and most preferably from 500 to 5 000.

Advantageously, homo- and copolymers of ethylene oxide, propylene oxide, butylene oxide and isobutylene oxide, which may be linear or branched, are used as the graft base. The term homopolymers shall, in accordance with the invention, also comprise those polymers which, apart from the polymerized alkylene oxide units, still comprise the reactive molecules which have been used to initiate the polymerization of the cyclic ether or for the end group capping of the polymer.

Branched polyethers can be prepared by, for example, adding ethylene oxide and, if desired, propylene oxide and/or butylene oxides or else polyglycerol onto low molecular weight polyalcohols (R₇ radicals in formulae IIIa and IIIb), for example pentaerythritol, glycerol and sugar, or sugar alcohols such as sucrose, D-sorbitol and D-mannitol, disaccharides.

This can form polymers in which at least one, preferably from one to eight, more preferably from one to five, of the hydroxyl groups present in the polyalcohol molecule can be bonded in the form of an ether bond to the polyether radical of the formula IIIa or IIIb.

Four-branched polymers can be obtained by adding the alkylene oxides onto diamines, preferably ethylenediamine.

Further branched polymers can be prepared by reacting alkylene oxides with higher-functionality amines, for example triamines, or especially polyethyleneimines. Polyethyleneimines suitable for this purpose generally have mean molecular weights Mn of from 300 to 20 000, preferably from 500 to 10 000 and more preferably from 500 to 5 000. The weight ratio of alkylene oxide to polyethyleneimine is typically from 100:1 to 0.1:1, preferably from 20:1 to 0.5:1.

Particular preference is given to using homo- and copolymers of ethylene oxide and/or propylene oxide as a graft base, which may be end group-capped at one or both ends.

The particular advantage of polypropylene oxide and copolymeric alkylene oxides with a high propylene oxide content is that the grafting proceeds readily. The particular advantage of polyethylene oxide and copolymeric alkylene oxides with a high ethylene oxide content is that, on completion of grafting and with the same grafting density as in the case of polypropylene oxide, the weight ratio of side chain to graft base is greater.

The K values of the inventive copolymers are typically from 10 to 150, preferably from 10 to 80 and more preferably from 15 to 60 (determined according to H. Fikentscher, Cellulose-Chemie, vol. 13, p. 58 to 64 and 71 to 74 (1932) in water or aqueous sodium chloride solutions at 25° C. (NaCl concentration from 0.1 to 7.0% by weight) and polymer concentrations which, according to the K value range are from 0.1% by weight to 5% by weight). The K value desired in each case can be established through the composition of the feedstocks.

The inventive copolymers can be prepared by free-radically polymerizing (a) at least one ethylenically unsaturated monomer whose homo- or copolymers exhibit thermally sensitive behavior, and (b) at least one ethylenically unsaturated monomer with a dye-affinitive group, and also, if appropriate, with monomers (c) different therefrom, if appropriate in the presence of a graft base.

The free-radical polymerization of the monomers can be performed by all known methods, such as solution polymerization, emulsion polymerization, suspension polymerization or bulk polymerization; preference is given to the processes of solution polymerization and of bulk polymerization, very particular preference to solution polymerization.

Advantageously, a solution polymerization is performed, i.e. the polymerization is effected in an organic solvent or solvent mixture, in water or in mixtures of water with organic solvents as the reaction medium. In a preferred embodiment, the reaction medium comprises predominantly organic solvents/solvent mixtures, i.e. the proportion of water is less than 30% by volume, especially less than 10% by volume, based on the total amount of solvents.

Examples of suitable organic solvents are alkyl acetates, e.g. ethyl acetate, aliphatic and cycloaliphatic monohydric C₁-C₄-alcohols, e.g. methanol, ethanol, n-propanol, isopropanol, n-butanol, sec-butanol and tert-butanol; polyhydric alcohols such as C₁-C₄-glycols, e.g. ethylene glycol, propylene glycol and butylene glycol and glycerol; mono- and dialkyl ethers of polyhydric alcohols, such as C₁-C₄-alkyl ethers of the polyhydric alcohols mentioned, e.g. monomethylethylene glycol, monoethylethylene glycol, dimethylethylene glycol and dimethylpropylene glycol; ether alcohols, e.g. diethylene glycol and triethylene glycol; and also cyclic ethers, e.g. dioxane. Preferred organic solvents are alkyl acetates and alcohols.

Suitable free-radical initiators are in particular peroxo compounds, azo compounds, redox initiator systems and reducing compounds. It will be appreciated that it is also possible to use mixtures of free-radical initiators.

Among the thermally activable polymerization initiators, preference is given to initiators having a decomposition temperature (“10 h half-life decomposition temperature”) in the range from 20 to 180° C., especially from 50 to 120° C. Examples of preferred thermal initiators are inorganic peroxo compounds such as peroxodisulfates (ammonium and alkali metal sulfates, preferably sodium peroxodisulfate), peroxosulfates, percarbonates and hydrogen peroxide; organic peroxo compounds such as diacetyl peroxide, di-tert-butyl peroxide, diamyl peroxide, dioctanoyl peroxide, didecanoyl peroxide, dilauroyl peroxide, dibenzoyl peroxide, bis(o-tolyl) peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumene hydroperoxide, tert-butyl peroxy-2-ethylhexanoate and diisopropyl peroxidicarbamate; azo compounds such as 2,2′-azobisisobutyronitrile, 2,2′-azobis(2-methylbutyronitrile) and azobis(2-amidinopropane) dihydrochloride.

These initiators may be used in combination with reducing compounds as starter/regulator systems. Examples of such reducing compounds include phosphorus compounds such as phosphorous acid, hypophosphites and phosphinates, sulfur compounds such as sodium hydrogen sulfite, sodium sulfite and sodium formaldehyde sulfoxylate, and also hydrazine. Suitable examples are also the tert-butyl hydroperoxide/sodium disulfite and tert-butyl hydroperoxide/sodium hydroxymethanesulfinate combinations; additionally systems with addition of small amounts of redox metal salts such as iron salts, for example ascorbic acid/iron(II) sulfate/sodium peroxodisulfate.

Preferred initiators are soluble in the polymerization medium in the amount used. Preference is therefore given to water-soluble initiators. Particularly preferred initiators are the aforementioned diazo compounds, especially water-soluble diazo compounds such as azobis(2-amidinopropane) dihydrochloride.

Photoinitiators are likewise suitable; for example benzophenone, acetophenone, benzoin ethers, benzyl dialkyl ketones and derivatives thereof.

According to the requirements of the material to be polymerized, the polymerization initiators are used typically in amounts of from 0.01 to 15% by weight, preferably from 0.25 to 8% by weight, based in each case on the monomers to be polymerized, and may be employed individually or in combination with one another to utilize advantageous synergistic effects.

To limit the molar masses of the inventive copolymers, customary regulators may be added in the polymerization, for example mercapto compounds such as mercaptoethanol, thioglycolic acid, 1,4-bismercaptobutane-2,3-diol; alkali metal sulfites and hydrogensulfites, such as sodium sulfite; alkali metal phosphites and hypophosphites, such as sodium hypophosphite, etc. Suitable amounts of regulator are generally in the range from 0.01 to 5% by weight, based on the monomers to be polymerized.

The polymerization temperature is generally in the range from 30 to 200° C., preferably from 50 to 150° C., more preferably from 60 to 90° C.

The polymerization may be performed under atmospheric pressure; if appropriate, it may also be undertaken in closed systems under the autogenous pressure which evolves.

Frequently, the preparation of the copolymers may also be followed by a chemical and/or physical deodorization, i.e. a removal of unconverted monomers. Physical deodorization removes the monomers from the polymerization mixture with steam, for example by distilling off part of the aqueous polymerization medium and/or by means of passing hot steam through. Chemical deodorization removes unconverted monomers in the reaction mixture by using more severe polymerization conditions, for example by adding further polymerization initiator, frequently by adding the abovementioned redox initiators and especially by adding hydroperoxides, such as hydrogen peroxide and alkyl hydroperoxides, e.g. tert-butyl hydroperoxide, in combination with reducing agents, especially sulfur-containing reducing agents, such as hydrogensulfite, dithionite, adducts of hydrogensulfite to ketones, such as the acetone-bisulfite adduct, hydroxymethanesulfinate and the like, if appropriate in the presence of traces of transition metals, e.g. Fe²⁺ or Fe³⁺.

The reaction mixtures obtained in the solution polymerization comprise the copolymer typically in a concentration of from 10 to 70% by weight, preferably from 20 to 60% by weight (solids content of the polymerization solution).

The inventive copolymers are used preferably in the form of their aqueous solution. Preference is given here to those copolymers which, in the form of their aqueous solution or emulsion, preferably have a neutral or basic pH. For the mixing with the other components in the washing composition, the copolymer solution may either be used directly or the pH is adjusted by adding bases or acids. The copolymer content of the aqueous solutions is typically in the range from 10 to 70% by weight, preferably from 20 to 60% by weight.

A preferred pH range for the blending is generally from 5 to 11, preferably from 6 to 10 and more preferably from 6.5 to 9, and is most preferably from 7 to 8.9.

The inventive copolymers may also be used in powder or granule form.

The dye transfer inhibitors are water-soluble below the LCST and may be used in solid and liquid washing compositions and in laundry aftertreatment compositions. They feature high compatibility with conventional washing composition constituents, especially with the constituents of liquid washing compositions.

Dye transfer to additionally washed fabric and the associated undesired discoloration of this fabric is effectively inhibited. Even at concentrations of from 10 to 150 ppm in the wash or rinse liquor, good to very good dye transfer-inhibiting effects are achieved.

The likewise inventive solid washing composition formulations comprise especially the following components:
(a) from 0.05 to 20% by weight of at least one thermally sensitive polymer,
(b) from 0.5 to 40% by weight of at least one non-ionic, anionic and/or cationic surfactant,
(c) from 0.5 to 50% by weight of an inorganic builder,
(d) from 0 to 10% by weight of an organic cobuilder and
(e) from 0.1 to 60% by weight of other customary ingredients, such as standardizers, enzymes, perfume, complexing agents, corrosion inhibitors, bleaches, bleach activators, bleach catalysts, further color protection additives and dye transfer inhibitors, graying inhibitors, soil-release polyesters, fiber protection additives, silicones, dyes, bactericides and preservatives, dissolution improvers and/or disintegrants, water,
   where the sum of components (a) to (e) adds up to 100% by weight.

The inventive solid washing composition formulations may be present in powder, granule, extrudate or tablet form.

The inventive liquid washing composition formulations preferably have the following composition:
(a) from 0.05 to 20% by weight of at least one thermally sensitive polymer,
(b) from 0.5 to 70% by weight of at least one non-ionic, anionic and/or cationic surfactant,
(c) from 0 to 20% by weight of an inorganic builder,
(d) from 0 to 10% by weight of an organic cobuilder,
(e) from 0.1 to 60% by weight of other customary ingredients, such as soda, enzymes, perfume, complexing agents, corrosion inhibitors, bleaches, bleach activators, bleach catalysts, further color protection additives and dye transfer inhibitors, graying inhibitors, soil-release polyesters, fiber protection additives, silicones, dyes, bactericides and preservatives, organic solvents, solubilizers, hydrotropes, thickeners and/or alkanolamines and
(f) from 0 to 99.35% by weight of water.

The inventive laundry aftertreatment compositions, especially laundry care rinsing agents, comprise preferably
(a) from 0.05 to 20% by weight of at least one thermally sensitive polymer,
(b) from 0.1 to 40% by weight of at least one cationic surfactant,
(c) from 0 to 30% by weight of at least one non-ionic surfactant,
(d) from 0.1 to 30% by weight of other customary ingredients, such as silicones, other lubricants, wetting agents, film-forming polymers, fragrances and dyes, stabilizers, fiber protection additives, further fiber protection additives and dye transfer inhibitors, complexing agents, viscosity modifiers, soil-release additives, solubilizers, hydrotropes, corrosion protection additives, bactericides and preservatives and
(e) from 0 to 99.75% by weight of water.

Suitable non-ionic surfactants (B) are in particular:
alkoxylated C₈-C₂₂-alcohols, such as fatty alcohol alkoxylates, oxo alcohol alkoxylates and Guerbet alcohol ethoxylates: the alkoxylation can be effected with ethylene oxide, propylene oxide and/or butylene oxide. Block copolymers or random copolymers may be present. Per mole of alcohol, they comprise typically from 2 to 50 mol, preferably from 3 to 20 mol, of at least one alkylene oxide. A preferred alkylene oxide is ethylene oxide. The alcohols have preferably from 10 to 18 carbon atoms;
alkylphenol alkoxylates, especially alkylphenol ethoxylates, which comprise C₆-C₁₄-alkyl chains and from 5 to 30 mol of alkylene oxide/mol;
alkylpolyglucosides which comprise C₈-C₂₂-alkyl chains, preferably C₁₀-C₁₈-alkyl chains, and generally from 1 to 20, preferably from 1.1 to 5 glucoside units;
N-alkylglucamides, fatty acid amide alkoxylates, fatty acid alkanolamide alkoxylates, long-chain amine oxides, polyhydroxy(alkoxy) fatty acid derivatives, for example polyhydroxy fatty acid amides, gemini surfactants, and block copolymers formed from ethylene oxide, propylene oxide and/or butylene oxide; and mixtures thereof.

Suitable anionic surfactants are, for example:
sulfates of (fatty) alcohols having from 8 to 22, preferably from 10 to 18 carbon atoms, especially C₉-C₁₁-alcohol sulfates, C₁₂-C₁₄-alcohol sulfates, C₁₂-C₁₈-alcohol sulfates, lauryl sulfate, cetyl sulfate, myristyl sulfate, palmityl sulfate, stearyl sulfate and tallow fat alcohol sulfate;
sulfated alkoxylated C₈-C₂₂-alcohols (alkyl ether sulfates): compounds of this type are prepared, for example, by first alkoxylating a C₈-C₂₂-alcohol, preferably a C₁₀-C₁₈-alcohol, for example a fatty alcohol, and then sulfating the alkoxylation product. For the alkoxylation, preference is given to using ethylene oxide;
linear C₈-C₂₀-alkylbenzenesulfonates (LAS), preferably linear C₉-C₁₃-alkyl-benzenesulfonates and alkyltoluenesulfonates;
alkanesulfonates, especially C₈-C₂₄-alkanesulfonates, preferably C₁₀-C₁₈-alkanesulfonates;
olefinsulfonates;
fatty acid sulfonates and fatty acid ester sulfonates;
soaps such as the sodium and potassium salts of C₈-C₂₄-carboxylic acids; and mixtures thereof.

The anionic surfactants are added to the washing composition preferably in the form of salts. Suitable salts are, for example, alkali metal salts such as sodium, potassium and lithium salts, and ammonium salts such as hydroxyethylammonium, di(hydroxyethyl)-ammonium and tri(hydroxyethyl)ammonium salts.

Particularly suitable cationic surfactants include:
C₇-C₂₅-alkylamines;
N,N-dimethyl-N-(hydroxy-C₇-C₂₅-alkyl)ammonium salts;
mono- and di(C₇-C₂₅-alkyl)dimethylammonium compounds quaternized with alkylating agents;
ester quats, especially quaternary esterified mono-, di- and trialkanolamines which have been esterified with C₈-C₂₂-carboxylic acids;
imidazoline quats, especially 1-alkylimidazolinium salts of the formulae II or III

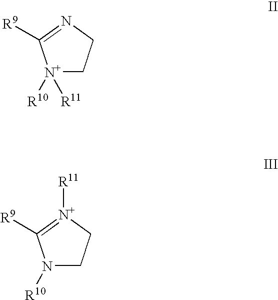

in which the variables are each defined as follows:
R⁹ is C₁-C₂₅-alkyl or C₂-C₂₅-alkenyl;
R¹⁰ is C₁-C₄-alkyl or hydroxy-C₁-C₄-alkyl;
R¹¹ is C₁-C₄-alkyl, hydroxy-C₁-C₄-alkyl or an R¹—(CO)—X—(CH₂)ₘ— radical (X: —O— or —NH—; m: 2 or 3),
where at least one R⁹ radical is C₇-C₂₂-alkyl.

Suitable amphoteric surfactants are, for example, alkyl betaines, alkylamide betaines, aminopropionates, aminoglycinates and amphoteric imidazolium compounds.

Suitable inorganic builders are in particular:
crystalline and amorphous aluminosilicates with ion-exchanging properties, in particular zeolites: various types of zeolites are suitable, especially zeolites A, X, B, P, MAP and HS in their Na form or in forms in which Na has been exchanged partly for other cations such as Li, K, Ca, Mg or ammonium;
crystalline silicates, especially disilicates and sheet silicates, for example δ- and β-Na₂Si₂O₅. The silicates may be used in the form of their alkali metal, alkaline earth metal or ammonium salts; preference is given to the Na, Li and Mg silicates;
amorphous silicates such as sodium metasilicate and amorphous disilicate;
carbonates and hydrogencarbonates: these may be used in the form of their alkali metal, alkaline earth metal or ammonium salts. Preference is given to the carbonates and hydrogencarbonates of sodium, lithium and magnesium, especially sodium carbonate and/or sodium hydrogencarbonate; and
polyphosphates such as pentasodium triphosphate.

Suitable organic cobuilders are in particular:
low molecular weight carboxylic acids, such as citric acid, hydrophobically modified citric acid, for example agaric acid, malic acid, tartaric acid, gluconic acid, glutaric acid, succinic acid, imidodisuccinic acid, oxydisuccinic acid, propanetricarboxylic acid, butanetetracarboxylic acid, cyclopentanetetracarboxylic acid, alkyl- and alkenylsuccinic acids and aminopolycarboxylic acids, for example nitrilotriacetic acid, β-alaninediacetic acid, ethylenediaminetetraacetic acid, serinediacetic acid, isoserinediacetic acid, N-(2-hydroxyethyl)iminoacetic acid, ethylenediaminedisuccinic acid and methyl- and ethylglycinediacetic acid or alkali metal salts thereof;
oligomeric and polymeric carboxylic acids, such as homopolymers of acrylic acid and aspartic acid, oligomaleic acids, copolymers of maleic acid with acrylic acid, methacrylic acid or C₂-C₂₂-olefins, for example isobutene or long-chain α-olefins, vinyl C₁-C₈-alkyl ethers, vinyl acetate, vinyl propionate, (meth)acrylic esters of C₁-C₈-alcohols and styrene. Preference is given to the homopolymers of acrylic acid and copolymers of acrylic acid with maleic acid. The oligomeric and polymeric carboxylic acids are used in acid form or as the sodium salt;
phosphonic acids, for example 1-hydroxyethylene(1,1-diphosphonic acid), aminotri(methylenephosphonic acid), ethylenediaminetetra(methylenephosphonic acid) and diethylenetriaminepenta(methylenephosphonic acid) and alkali metal salts thereof.

Suitable graying inhibitors are, for example, carboxymethylcellulose and graft polymers of vinyl acetate to polyethylene glycol.

Suitable bleaches are, for example, adducts of hydrogen peroxide to inorganic salts, such as sodium perborate monohydrate, sodium perborate tetrahydrate and sodium carbonate perhydrate, and percarboxylic acids such as phthalimidopercaproic acid.

Suitable bleach activators are, for example, N,N,N′,N′-tetraacetylethylenediamine (TAED), sodium p-nonanoyloxybenzenesulfonate and N-methylmorpholinio-acetonitrile methylsulfate.

Enzymes used with preference in washing compositions are proteases, lipases, amylases, cellulases, oxidases and peroxidases.

Suitable further dye transfer inhibitors are, for example, homopolymers, copolymers and graft polymers of 1-vinylpyrrolidone, 1-vinylimidazole or 4-vinylpyridine N-oxide. Homo- and copolymers of 4-vinylpyridine which have been reacted with chloroacetic acid are also suitable as dye transfer inhibitors.

Washing composition ingredients are otherwise common knowledge. Detailed descriptions can be found, for example, in WO-A-99/06524 and 99/04313; in Liquid Detergents, Editor: Kuo-Yann Lai, Surfactant Sci. Ser., Vol. 67, Marcel Decker, New York, 1997, p. 272-304.

### Use of Inventive LCST Polymers

Selected colored fabric (EMPA 130, EMPA 132, EMPA 133 or EMPA 134) was washed in the presence of white cotton test fabric and ballast fabric made of cotton/polyester and of polyester with a washing composition at 60° C. with addition of the LCST polymers. After the wash cycle, the fabrics were rinsed, spun and dried. In order to determine the dye transfer-inhibiting action, the staining of the white test fabric was determined photometrically (Photometer: Elrepho® 2000 from Datacolor). The reflectance values measured on the test fabric were used to determine the color strength of the stain by the method described in A. Kud, Seifen, Öle, Fette, Wachse, Volume 119, page 590-594 (1993). The color strength for the experiment with the particular test substance, the color strength for the experiment without test substance and the color strength of the test fabric before the wash were used to determine the dye transfer-inhibiting action of the test substance by the following formula in %.

$$DTI action [ \% ] = \frac{\begin{matrix}Color strength ( without polymer ) - \\ Color strength ( with polymer )\end{matrix}}{\begin{matrix}Color strength ( without polymer ) - \\ Color strength ( before the wash )\end{matrix}} \times 100$$

The wash conditions are specified in table 1.

The composition of the washing compositions A and B used are reproduced in tables 2 and 3.

The test results for dye transfer inhibition are listed in table 4.

TABLE 1
Wash conditions
Main wash cycle wash conditions

| | |
|---|---|
| Machine | Launder-o-meter from Atlas, Chicago, USA |
| Washing | 5.0 g/l of liquor for washing composition A |
| composition | 4.5 g/l of liquor for washing composition B |
| dosage | |
| Water hardness | 3 mmol/l Ca:Mg 4:1 |
| Liquor ratio | 1:16 |
| Wash temperature | 60° C. |
| Wash time | 30 min |
| Polymer dosage | 0.05 g/l of liquor |
| Colored fabric | 1 g of EMPA 130 (C.I. Direct Red 83:1) |
| | 1 g of EMPA 132 (C.I. Direct Black 22) |
| | 1 g of EMPA 133 (C.I. Direct Blue 71) |
| | 0.5 g of EMPA 134 (C.I. Direct Orange 39) |
| | (all from Eidgenössische Materialprüfungsanstalt |
| | [Swiss Federal Materials Testing Institute], |
| | St. Gallen, Switzerland) |
| Test fabric | 5 g of cotton fabric 221 (bleached) |
| Ballast fabric | 5 g of mixed fabric 768 (65:35 PES:BW) + |
| | 5 g of polyester fabric 854 |

TABLE 2
Composition of washing composition A

| Ingredients | [% by wt.] |
|---|---|
| Linear alkylbenzenesulfonate | 3 |
| C₁₃-C₁₅-Oxoalcohol × 7 EO | 12 |
| C₆-Alcohol × 5 EO | 5 |
| Citric acid | 3 |
| Propylene glycol | 10 |
| Ethanol | 2 |
| Diethylenetriaminepenta(methylenephosphonic acid) | 1.0 |
| Water | to 100 |

Adjust to pH 9 with sodium hydroxide solution.

TABLE 3
Composition of washing composition B

| Ingredients | [% by wt.] |
|---|---|
| Linear alkylbenzenesulfonate | 8 |
| C₁₃-C₁₅-Oxoalcohol × 7 EO | 8 |
| Zeolite A | 40 |
| Sodium carbonate | 12 |
| Sodium metasilicate | 4 |
| Sodium citrate × 2 H₂O | 8 |
| Acrylic acid/maleic acid copolymer, Na salt (AA/MA weight | 3 |
| ratio 70:30, M_{w} 70 000) | |
| Carboxymethylcellulose | 1.0 |
| Soap | 1.5 |
| Sodium sulfate | 7.5 |
| Water | to 100 |

### Preparation of the Inventive Copolymers

### Polymer 1:

In a 2 l polymerization apparatus with anchor stirrer and internal thermometer, a mixture of 210 g of polyethylene glycol monomethyl ether (MW 1500), 12 g of ethyl acetate and 4 g from feed 2 was sparged with nitrogen and heated to 77° C. After stirring at 77° C. for 4 minutes, feed 1 consisting of 300 g of vinylcaprolactam, 90 g of 1-vinylimidazole and 180 g of ethyl acetate was metered in within 5 hours, and feed 2 consisting of 5.85 g of t-butyl perpivalate (75%) and 50 g of ethyl acetate within 5.5 hours. Subsequently, feed 3 consisting of 5.2 g of t-butyl perpivalate (75%) and 44 g of ethyl acetate was added. The reaction mixture was stirred at 77° C. for a further 4 hours, and then a steam distillation was performed at from 93 to 100° C. This afforded a clear yellow polymer solution.

### Polymer 2:

In a 2 l polymerization apparatus with anchor stirrer and internal thermometer, a mixture of 210 g of polyethylene glycol monomethyl ether (MW 1500), 12.0 g of ethyl acetate and 4 g from feed 2 were sparged with nitrogen and heated to 77° C. After 4 minutes, feed 1 consisting of 240 g of vinylcaprolactam, 75 g of vinylpyrrolidone, 75 g of vinylimidazole and 180 g of ethyl acetate was metered in within 5 hours with stirring, and feed 2 consisting of 5.85 g of t-butyl perpivalate (75%) and 50 g of ethyl acetate within 5.5 hours. Subsequently, feed 3 consisting of 5.2 g of t-butyl perpivalate (75%) and 44 g of ethyl acetate was added. The mixture was stirred at 77° C. for a further 4 hours. Subsequently, a steam distillation was at from 93 to 100° C. A yellow clear polymer solution was obtained.

### Polymer 3:

In a 2 l polymerization apparatus with anchor stirrer and internal thermometer, a mixture of 120 g of polyethyleneimine (MW 2000), 12.0 g of ethyl acetate and 4 g from feed 2 were sparged with nitrogen and heated to 77° C. After 4 minutes, feed 1 consisting of 240 g of vinylcaprolactam, 120 g of vinylpyrrolidone, 120 g of vinylimidazole and 180 g of ethyl acetate was metered in within 5 hours with stirring, and feed 2 consisting of 7.2 g of t-butyl perpivalate (75%) and 50 g of ethyl acetate within 5.5 hours. Subsequently, feed 3 consisting of 6.4 g of t-butyl perpivalate (75%) and 44 g of ethyl acetate was added. The mixture was stirred at 77° C. for a further 4 hours. Subsequently, a steam distillation was at from 93 to 100° C. A yellow clear polymer solution was obtained.

### Polymer 4:

In a 2 l polymerization apparatus with anchor stirrer and internal thermometer, a mixture of 120 g of polyethylene glycol monomethyl ether (MW 6000), 95 g of ethyl acetate and 4 g from feed 2 were sparged with nitrogen and heated to 77° C. After 4 minutes, feed 1 consisting of 300 g of vinylcaprolactam, 180 g of vinylimidazole and 100 g of ethyl acetate was metered in within 5 hours with stirring, and feed 2 consisting of 7.2 g of t-butyl perpivalate (75%) and 50 g of ethyl acetate within 5.5 hours. Subsequently, feed 3 consisting of 6.4 g of t-butyl perpivalate (75%) was added. The mixture was stirred at 77° C. for a further 4 hours. Subsequently, a steam distillation was at from 93 to 100° C. A yellow clear polymer solution was obtained.

### Polymer 5:

In a 2 l polymerization apparatus with anchor stirrer and internal thermometer, 200 g of ethyl acetate were sparged with nitrogen and heated to 77° C. On attainment of this temperature, feed 3 consisting of 20.4 g of t-butyl perpivalate (75%) in 140 g of ethyl acetate was started and added within 5.5 hours. After stirring at 77° C. for 4 minutes, feed 1 consisting of 53.9 g of polyethylene glycol monomethyl ether monoacrylate (MW 1000) (83.5% in toluene) in 130 g of ethyl acetate, and feed 2 consisting of 150 g of vinylcaprolactam and 105 g of vinylimidazole, were metered in within 5 hours. After feed 3 had ended, feed 4 consisting of 3.4 g of t-butyl perpivalate (75%) in 20 g of ethyl acetate was added. The reaction mixture was stirred at 77° C. for a further 4 hours. Subsequently, a steam distillation was performed at from 93 to 100° C. A yellow clear polymer solution was obtained.

TABLE 4
Analysis values for polymer 1-5

| | | | Cloud point (° C.) |
|---|---|---|---|
| | | | (1% by weight |
| Polymer | Solids content (%) | K value | solution in water) |
| 1 | 37 | 23.2 | 36 |
| 2 | 49.9 | 24.1 | 48 |
| 3 | 44.6 | 24.6 | 54 |
| 4 | 19.6 | 42.7 | 36 |
| 5 | 39.0 | 30.6 | 42 |

The K values reported were determined according to H. Fikentscher, Cellulose-Chemie, Volume 13, page 58-64 and 761-774 (1932) as a 1% by weight solution in water at 25° C.

The cloud points (or LCSTs) of the polymers were determined in a 1% solution in water. (Temperature range from 20 to 80° C., heating rate of 1 degree Celsius per minute, both in the course of heating and cooling)

TABLE 5
Use of liquid washing composition A

| | DTI action [%] | | | |
|---|---|---|---|---|
| | EMPA 130 | EMPA 132 | EMPA 133 | EMPA 134 |
| Polymer 1 | 91.1 | 54.4 | 94.5 | 61.3 |
| Polymer 2 | 90.6 | 53.4 | 95.0 | 63.8 |
| Polymer 3 | 79.3 | 58.7 | 95.4 | 70.7 |
| Polymer 4 | 86.2 | 63.3 | 95.7 | 78.3 |
| Polymer 5 | 89.7 | 49.5 | 92.8 | 60.0 |
| PVP | 26.4 | 28.7 | 94.7 | 31.4 |

PVP = Polyvinylpyrrolidone with K value 30

TABLE 6
Use of solid washing composition B

DTI action [%]

| | EMPA 130 | EMPA 133 |
|---|---|---|
| Polymer 3 | 70.2 | 91.3 |
| Polymer 4 | 89.2 | 90.8 |
| PVP | 47.4 | 92.7 |

1. A method for inhibiting dye transfer during washing of colored textiles with a detergent composition, which method comprises contacting said textiles with a thermally sensitive polymer which has a lower critical solution temperature (LCST) in an amount which is effective for inhibiting dye transfer.

2. The method according to claim 1, wherein the LCST of the thermally sensitive polymer is in the range from 20 to 80° C.

3. The method according to claim 1, wherein the thermally sensitive polymer is a copolymer of ethylenically unsaturated monomers M which comprise at least one monoethylenically unsaturated monomer (a) whose homo- and/or copolymers exhibit thermally sensitive behavior, and (b) at least one monoethylenically unsaturated monomer (b) with a dye-affinitive group.

4. The method according to claim 3, wherein the monomers M, based on the total amount of the monomers M, comprise
i. from 20 to 80% by weight of at least one monomer (a) and
ii. from 5 to 50% by weight of at least one monomer (b) and
iii. up to 40% by weight of one or more monomers (c) other than monomers (a) and (b).

5. The method according to claim 4, wherein monomer (a) is selected from N-vinyl-lactams having a ring size of at least 6 atoms, N-mono-C₁-C₈-alkyl(meth)acrylamides, N,N-di-C₁-C₈-alkyl(meth)acrylamides, hydroxy-C₂-C₄-alkyl (meth)acrylates, vinyl alcohol and C₁-C₈-alkyl vinyl ethers.

6. The method according to claim 5, wherein the monomer (a) is selected from N-vinylcaprolactam, N-isopropylacrylamide, hydroxypropyl acrylate, vinyl alcohol and vinyl methyl ether.

7. The method according to claim 6, wherein the monomer (a) is N-vinylcaprolactam.

8. The method according to claim 3, wherein the dye-affinitive group in the monomer (b) is a 5- or 6-membered nitrogen heterocycle which may be fused.

9. The method according to claim 8, wherein the monomer (b) is selected from N vinylimidazole, quaternized N-vinylimidazole N-vinylpyrrolidone, N-vinyltriazole, N-vinylbenzimidazole, hydroxyethylpyrrolidone (meth)acrylate and hydroxyethylimidazole (meth)acrylate, 2-vinylpyridine, 4-vinylpyridine and derivatives thereof.

10. The method according to claim 9, wherein the monomer (b) is N-vinylimidazole.

11. The method according to claim 3, wherein the monomers M comprise at least one monomer (c) which is selected from monoethylenically unsaturated compounds having a poly-C₂-C₆-alkylene oxide group.

12. The method according to claim 3, wherein the copolymer is obtainable by copolymerizing the monomers M in the presence of a graft base.

13. The method according to claim 12, wherein the graft base is selected from poly-C₂ C₄-alkylene ethers and poly-C₂-C₄-alkyleneimines.

14. The method according to claim 12, wherein the weight ratio of graft base to the total amount of ethylenically unsaturated monomers M is in the range from 1:10 to 1:1.

15. A process for washing colored textiles comprising
(a) contacting the textiles with a dye transfer inhibitor comprising a thermally sensitive polymer having a lower critical solution temperature (LCST) in an amount which is effective for inhibiting dye transfer and at least one surfactant in a wash liquor,
(b) raising the temperature of the wash liquor to the LCST of the thermally sensitive polymer or a higher temperature, and
(c) removing the thermally sensitive polymer from the textiles with the wash liquor.

16. A copolymer comprising unsaturated monomers M and optionally a graft base, wherein the monomers M comprise at least one monoethylenically unsaturated monomer (a) whose homo- or copolymers exhibit thermally sensitive behavior, and (b) at least one monoethylenically unsaturated monomer (b) with a dye-affinitive group.

17. The copolymer according to claim 16, wherein the monomer (a) is selected from N-vinylcaprolactam, N-isopropylacrylamide, hydroxypropyl acrylate, vinyl alcohol and vinyl methyl ether, and the dye-affinitive group in the monomer (b) is a 5- or 6 membered nitrogen heterocycle which may be fused.

18. The copolymer according to claim 16, wherein the monomers M comprise at least one monomer (c) which is selected from monoethylenically unsaturated compounds with a poly-C₂-C₆-alkylene oxide group.

19. The copolymer according to claim 16, wherein the graft base is selected from polyalkylene oxides and polyalkyleneimines.

20. A washing composition formulation comprising at least one copolymer according to claim 16, at least one surfactant and at least one ingredient which is typical of washing compositions and is selected from inorganic builders, organic cobuilders, standardizers, soda, enzymes, perfume, complexing agents, corrosion inhibitors, bleaches, bleach activators, bleach catalysts, further color protection additives and dye transfer inhibitors, graying inhibitors, soil-release polyesters, fiber protective additives, silicones, dyes, bactericides, preservatives, dissolution improvers and disintegrants.
